(19) United States
(12) Patent Application Publication
(10) Pub. No.: US 2019/0195010 A1
(43) Pub. Date: Jun. 27, 2019

(54) ANTI-FOLDER HAND SAFETY DOOR

(71) Applicant: SUN-Q DOOR CONTROLS LIMITED, Yuanlin City (TW)

(72) Inventor: Shun-Hsien YU, YUANLIN CITY (TW)

(21) Appl. No.: 15/875,622

(22) Filed: Jan. 19, 2018

(30) Foreign Application Priority Data
Dec. 27, 2017 (TW) 106146081

(51) Int. Cl. E06B 7/36; E05D 1/00; E06B 7/16

(52) U.S. Cl. CPC E06B 7/362; E05Y 2900/132; E06B 7/16; E05D 1/00

(57) ABSTRACT

An anti-folder hand safety door includes a door frame having a recess vertically disposed in one inner lateral side thereof, a door panel having a convex hanging stile that is received in the recess of the door frame to shield the door gap between the door panel and the door frame, an adjustment mechanism mounted in the bottom side of the door panel to ensure that the convex hanging stile of the door panel is kept in the recess of the frame when the door panel is closed and including a locating shaft and a fixed gear affixed to the locating shaft, and a door closer including a body mounted in the door panel and pivotally connected to the locating shaft, a rotating shaft mounted in the body and a transmission gear meshed with the fixed gear.

### BACKGROUND OF THE INVENTION

### 1. Field of the Invention

The present invention relates to door technology and more particularly, to an anti-folder hand safety door.

### 2. Description of the Related Art

Generally speaking, the door panel and the door frame are pivotally connected to each other with hinges so that the door panel can be opened and closed relative to the door frame under the user's operation. In this case, the gap between the door panel and the door frame will gradually expand or contract as the door panel is being opened or closed.

When the door is opened, children frolicking around the door are likely to accidentally put their hands in the door gap, and if someone else has just closed the door, it is easy to get a finger jammed accident, such accident is sometimes unavoidable even for adults. Thus, the conventional doors are structurally invisible to some degree of danger, and there is still room for improvement in the use of safety.

### SUMMARY OF THE INVENTION

The present invention has been accomplished under the circumstances in view. It is the main object of the present invention to provide an anti-folder hand safety door, which prevents jammed finger injuries to ensure safe use without affecting closing and opening of the door panel.

To achieve this and other objects of the present invention, an anti-folder hand safety door comprises a door frame, a door panel, an adjustment mechanism and a door closer. The door frame comprises a header, a threshold, a first door jamb and a second door jamb. The first door jamb and the second door jamb are bilaterally connected between the header and the threshold to face toward each other. The first door jamb comprises a recess located on one side thereof and facing toward the second door jamb. The door panel comprises a top side pivotally connected to the header of the door frame, an opposing bottom side, a mounting hole defined in the bottom side and a convex hanging stile located on one lateral side thereof and facing toward the first door jamb of the door frame. The convex hanging stile is received in the recess of the first door jamb of the door frame when the door panel is closed in the door frame. The adjustment mechanism comprises a holder frame, a movable plate, a locating shaft and a fixed gear. The holder frame is mounted to a top surface of the threshold of the door frame adjacent to the first door jamb of the door frame. The movable plate is mounted in the holder frame and movable toward the first door jamb of the door frame. The locating shaft has a bottom side thereof affixed to the movable plate. The fixed gear is fixedly mounted on the locating shaft. The door closer comprises a body, a rotating shaft and a transmission gear. The body is mounted in the mounting hole of the door panel and pivotally connected to an opposing top side of the locating shaft so that the body is turnable about the locating shaft when the door panel is opened from the door frame. The rotating shaft is rotatable mounted in the body with a top end thereof disposed inside the body and an opposing bottom end thereof extended outside the body. The transmission gear is affixed to the bottom end of the rotating shaft and meshed with the fixed gear of the adjustment mechanism. Thus, when opening or closing the door panel, the transmission gear is driven by the rotating shaft to turn around the fixed gear. Since the fixed gear is not rotatable, the transmission gear will rotate on its own axis when turned around the fixed gear. Thus, the rotating shaft can be rotated with the transmission gear to drive a damping unit in the body, causing the damping unit to squeeze a hydraulic oil in producing a resistance against the opening or closing action of the door panel.

From the above we can see that the anti-folder hand safety door of the present invention utilizes the matching between the recess of the door frame and the convex hanging stile of the door panel to shield the door gap between the door panel and the door frame when the door panel is opened through an angle. After installation of the door panel or after several uses of the door panel, the adjustment screw can be rotated to adjust the position of the movable plate relative to the first door jamb of the door frame, ensuring that the convex hanging stile of the door panel can be received in the recess of the door frame when the door panel is closed. Thus, the anti-folder hand safety door prevents jammed finger injuries to ensure safe use without affecting closing and opening of the door panel, and allows adjustment of the position of the door panel at any time in a convenient manner, achieving the purpose of enhancing the safety and convenience of use.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of an anti-folder hand safety door in a close status in accordance with the present invention.

FIG. 2 is an oblique top elevational view of the door frame of the anti-folder hand safety door in accordance with the present invention.

FIG. 3 an oblique top elevational view of the door panel of the anti-folder hand safety door in accordance with the present invention.

FIG. 4 is a plain view of the anti-folder hand safety door, illustrating the relative positioning between the pivot set and the door closer.

FIG. 5 is a sectional view taken along line 5-5 of FIG. 4.

FIG. 6 is an enlarged view of a part of FIG. 5.

FIG. 7 is similar to FIG. 5, illustrating the door panel opened at 45°.

FIG. 8 is similar to FIG. 7, illustrating the door panel opened at 90′.

FIG. 9 is an exploded view of the adjustment mechanism of the anti-folder hand safety door in accordance with the present invention.

FIG. 10 is a plain view of the adjustment mechanism of the anti-folder hand safety door in accordance with the present invention, illustrating four abutment members respectively stopped against the two opposite lateral sides of the movable plate.

FIG. 11 is a sectional view of a part of the adjustment mechanism of the anti-folder hand safety door in accordance with the present invention.

FIG. 12 is similar to FIG. 11, illustrating the adjustment screw rotated, the movable plate moved toward the first door jamb of the door frame.

FIG. 13 is a sectional view of a part of the adjustment mechanism of the anti-folder hand safety door in accordance with the present invention, illustrating the relationship between the locating shaft, the d gear, the transmission gear and the rotating shaft.

FIG. 14 is similar to FIG. 13, illustrating the transmission gear rotated on the axis thereof and turned around the fixed gear.

### DETAILED DESCRIPTION OF THE INVENTION

The advantages and features of the present invention will be fully understood by reference to the following specification in conjunction with the accompanying drawings, in which the directional terms such as “top”, “bottom”, “inner”, “outer”, “front”, “back” are descriptive terms based on the normal direction of use but not intended to limit the scope of the invention.

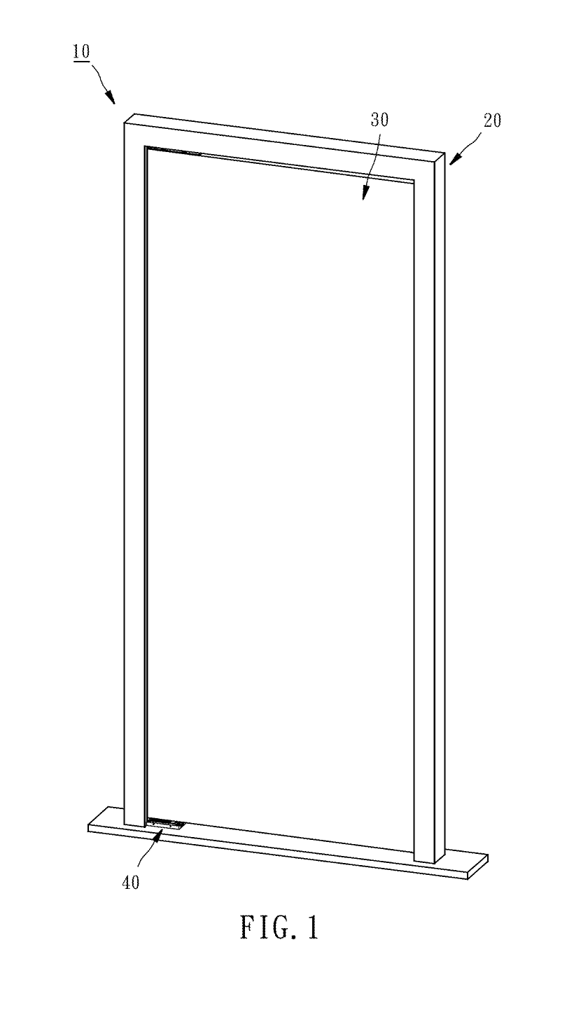

Referring to FIGS. 1-4, an anti-folder hand safety door 10 in accordance with the present invention is shown. The anti-folder hand safety door 10 comprises a door frame 20, a door panel 30, a spindle 40 and a cutter module 50.

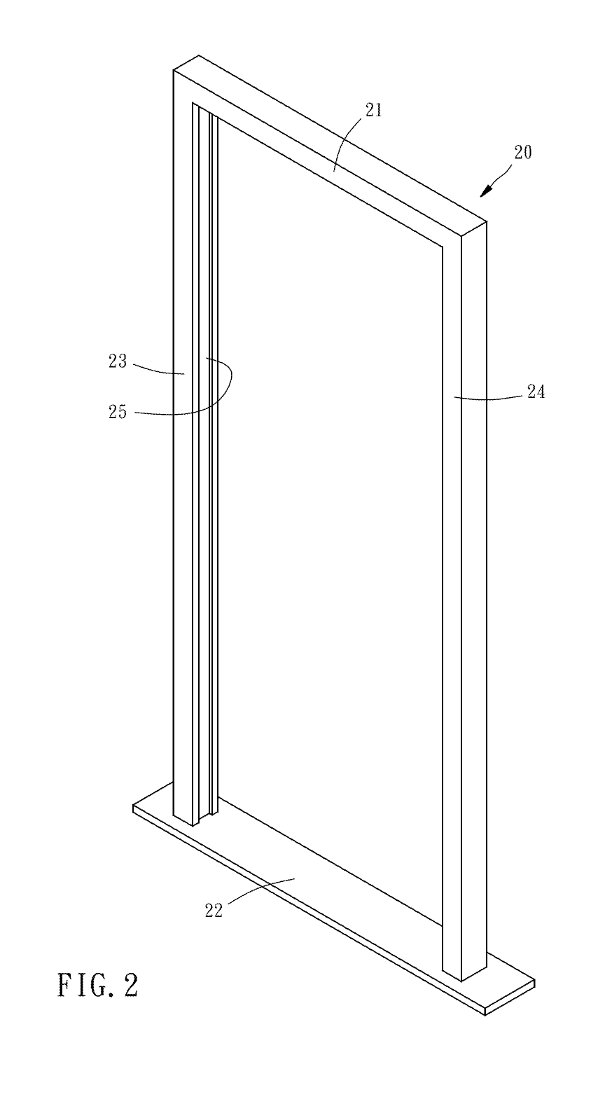

Referring to FIG. 2, the door frame 20 comprises a header 21, a threshold 22. A first door jamb 23 and a second door jamb 24. The first door jamb 23 and the second door jamb 24 are respectively bilaterally connected between the header 21 and the threshold 22. The first door jamb 23 comprises a recess 25 located on an inner side thereof and facing toward the second door jamb 24. The recess 25 is a rectangular groove (see FIG. 6) extended from a bottom side of the header 21 to a top side of the threshold 22.

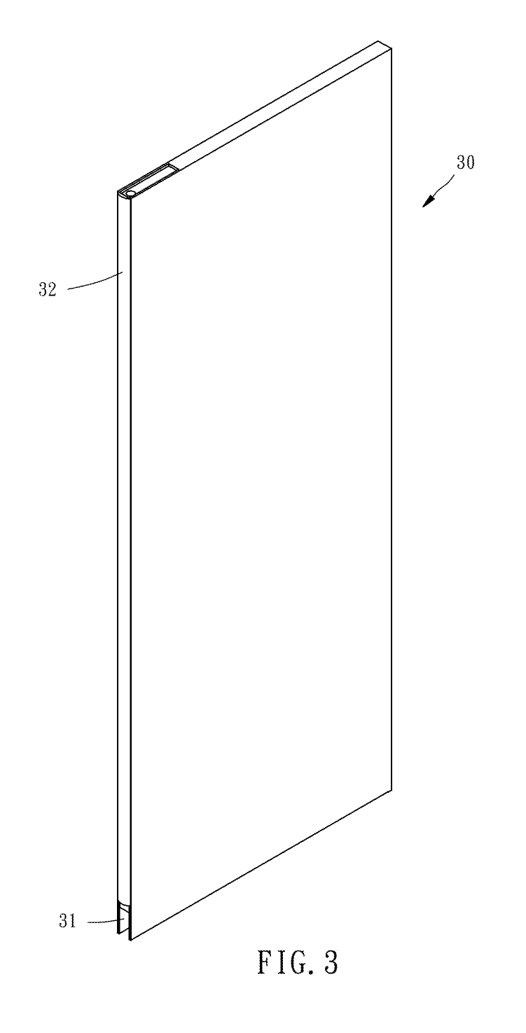

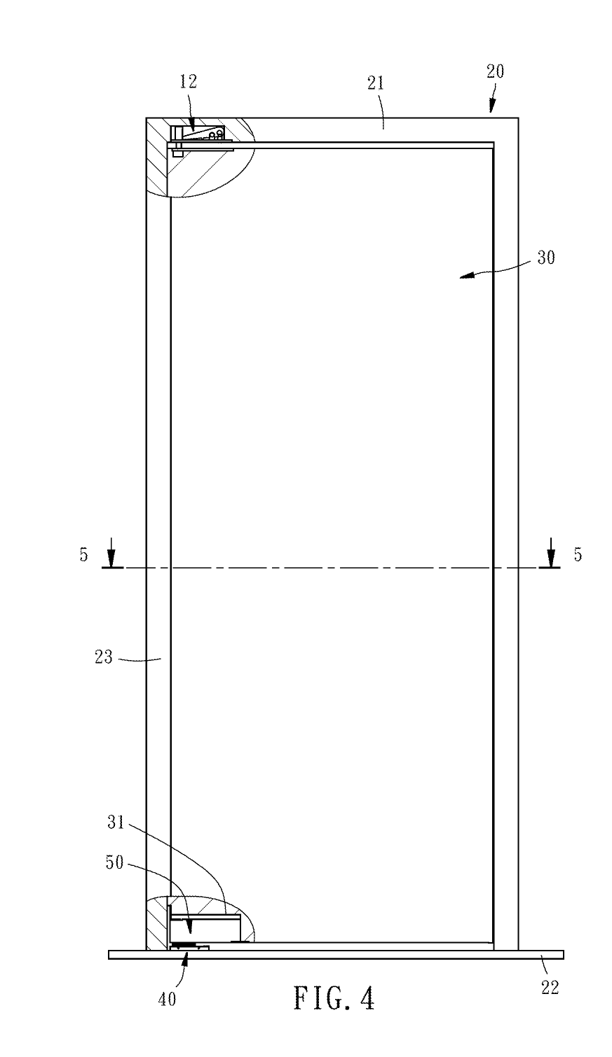

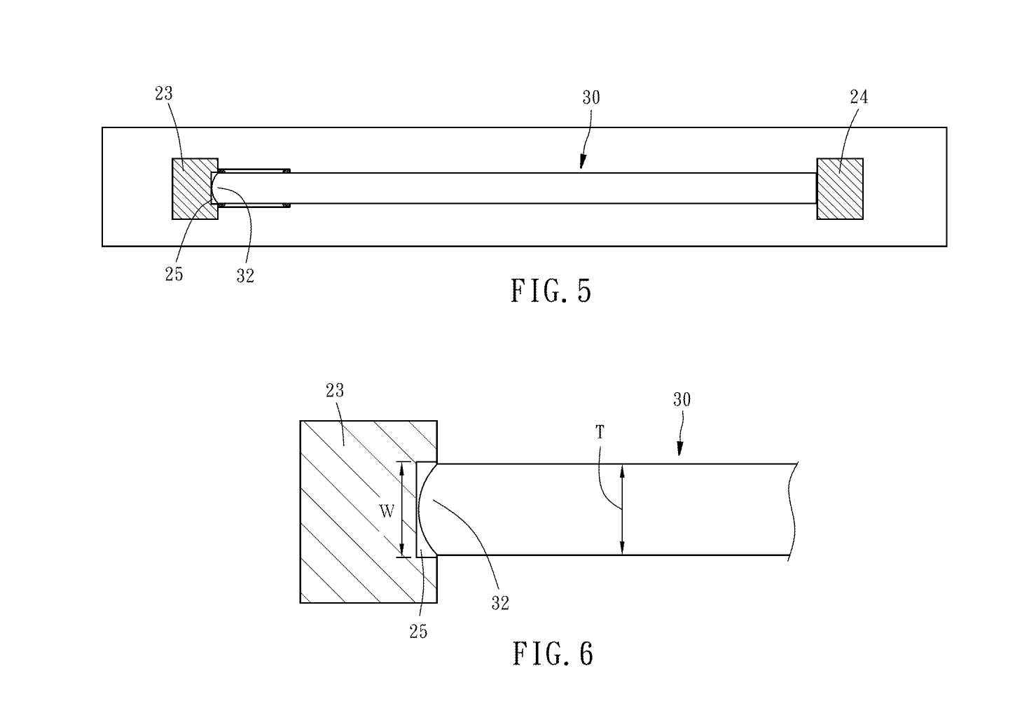

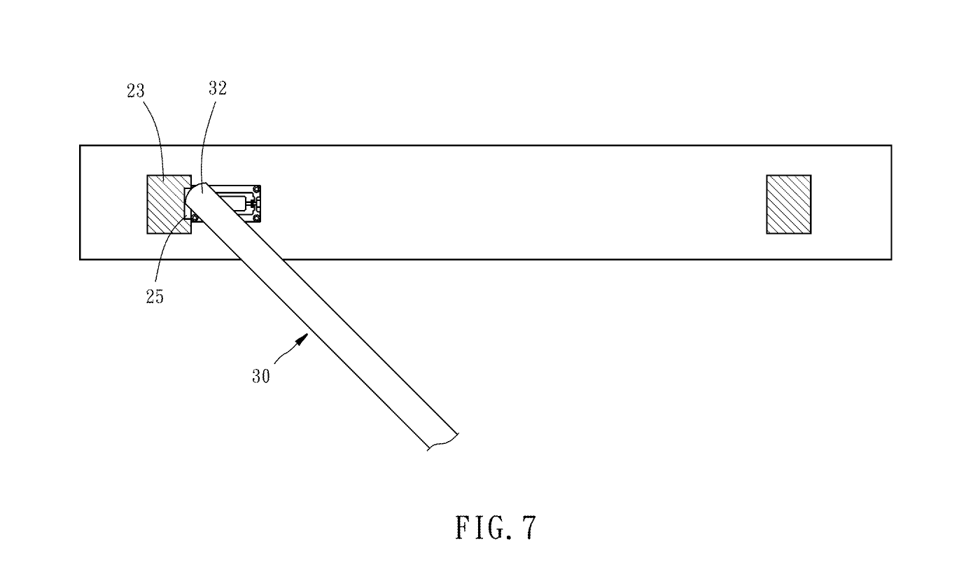

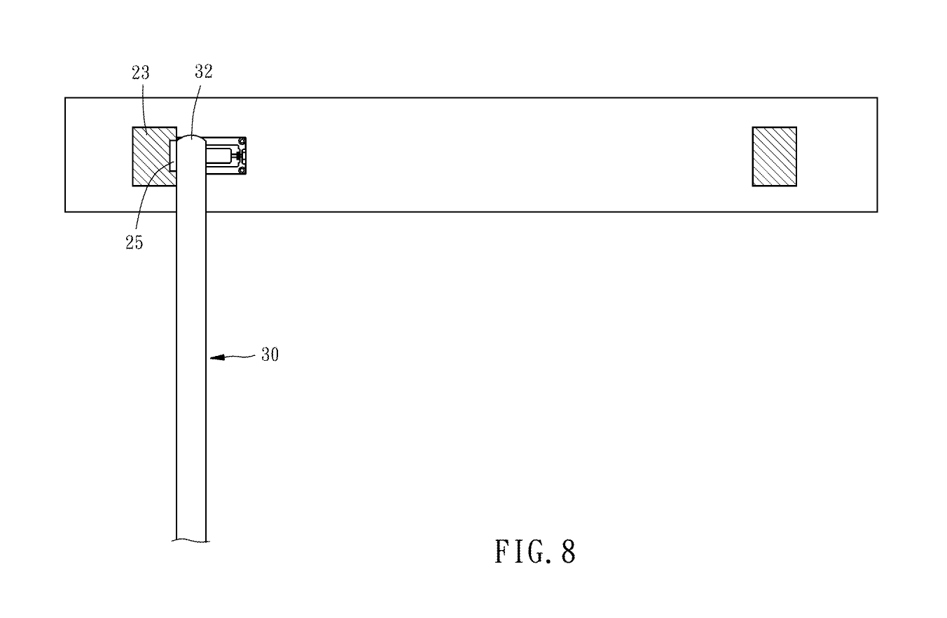

As illustrated in FIG. 4, the door panel 30 has one end of a top side thereof pivotally connected to one end of the header 21 of the door frame 20 by a pivot set 12 (this is of the known art and not within the scope of the invention, and we will not go into details herein). As illustrated in FIGS. 3 and 4, the door panel 30 comprises a mounting hole 31 defined in an opposing bottom side thereof adjacent to the first door jamb 23 of the door frame 20, a convex hanging stile 32 located on one lateral side thereof and facing toward the first door jamb 23 of the door frame 20, as illustrated in FIG. 3. The extending length of the convex hanging stile 32 is equal to the extending length of the recess 25 of the door frame 20. Further, as illustrated in FIG. 6, the thickness T of the door panel 20 is smaller than the width W of the recess 25 so that when the door panel 30 is closed, as illustrated in FIG. 5, the convex hanging stile 32 of the door panel 30 is received in the recess 25 of the first door jamb 23 of the door frame 20. If the door panel 30 is opened, the convex hanging stile 32 of the door panel 30 will be partially or completely moved out of the recess 25 of the first door jamb 23 of the door frame 20 according to the opening angle of the door panel 30. For example, when the door panel 30 is opened at 45°, as illustrated in FIG. 7, one half of the convex hanging stile 32 of the door panel 30 is disposed outside the recess 25 of the first door jamb 23 of the door frame 20, and the other half of the convex hanging stile 32 of the door panel 30 is received in the recess 25 of the first door jamb 23 of the door frame 20; when the door panel 30 is opened at 90′, as illustrated in FIG. 8, the convex hanging stile 32 of the door panel 30 is completely disposed outside the recess 25 of the first door jamb 23 of the door frame 20.

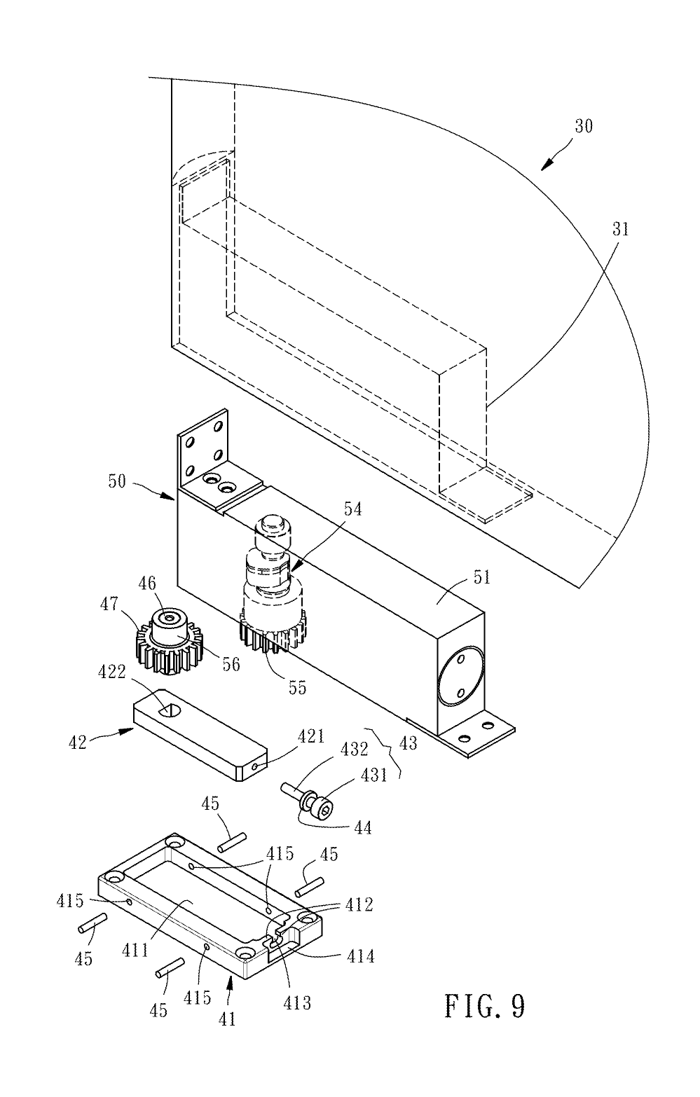

Referring to FIG. 9, the adjustment mechanism 40 comprises a holder frame 41, a movable plate 42, an adjustment screw 43, a stop ring 44, two pairs of abutment members 45, a locating shaft 46 and a fixed gear 47.

The holder frame 41 is mounted to the top side of the threshold 22 of the door frame 20 (see FIG. 1 and FIG. 4), comprising an accommodation chamber 411, two stop portions 412 disposed at one end thereof and facing toward each other, a gap 413 defined between the two stop portions 412 and disposed in communication with the accommodation chamber 411, and an end groove 414 located on the same one end relative to the two stop portions 412 and disposed in communication with the gap 413. The holder frame 41 has an opposite end thereof abutted against the first door jamb 23 of the door frame 20. The holder frame 41 further comprises two pairs of through holes 415 symmetrically located on two opposite long sides thereof and respectively disposed in communication with the accommodation chamber 411.

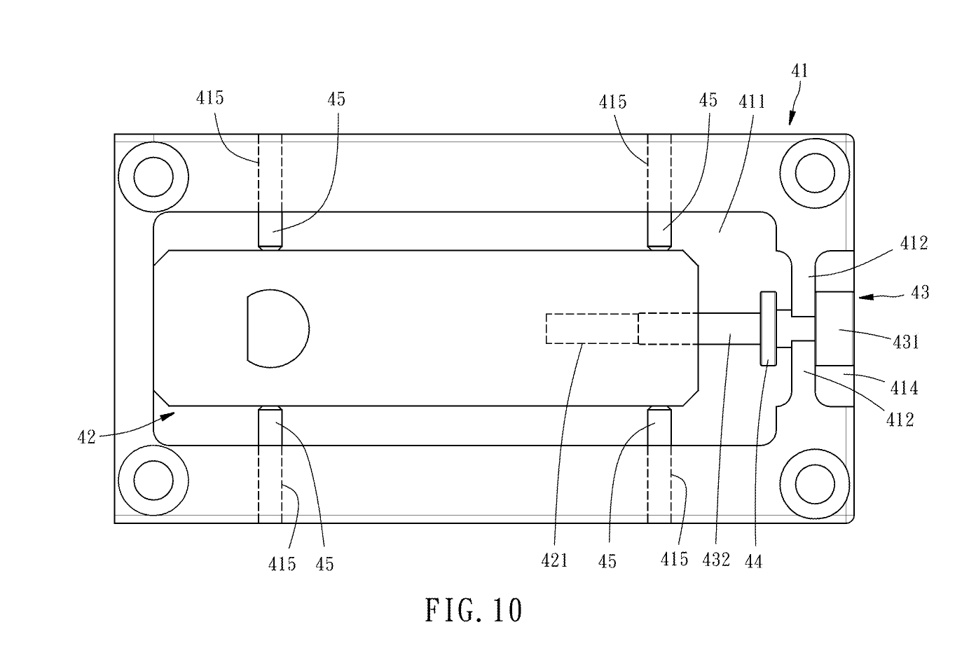

The movable plate 42 is mounted in the accommodation chamber 411 of the holder frame 40, as illustrated in FIG. 10. The length and width of the movable plate 42 are respectively smaller than the length and width of the accommodation chamber 411 of the holder frame 40 so that the movable plate 42 can be moved back and forth as well as left and right. Further, the movable plate 42 comprises an adjustment screw hole 421 located on a right end thereof (the end adjacent to the stop portions 412 of the holder frame 41). The axial direction of the adjustment screw hole 421 extends perpendicular to the axial direction of the through holes 415 of the holder frame 41. The movable plate 42 further comprises a non-circular locating hole 422 located on an opposite left end thereof (i.e., the end remote from the stop portions 412 of the holder frame 41).

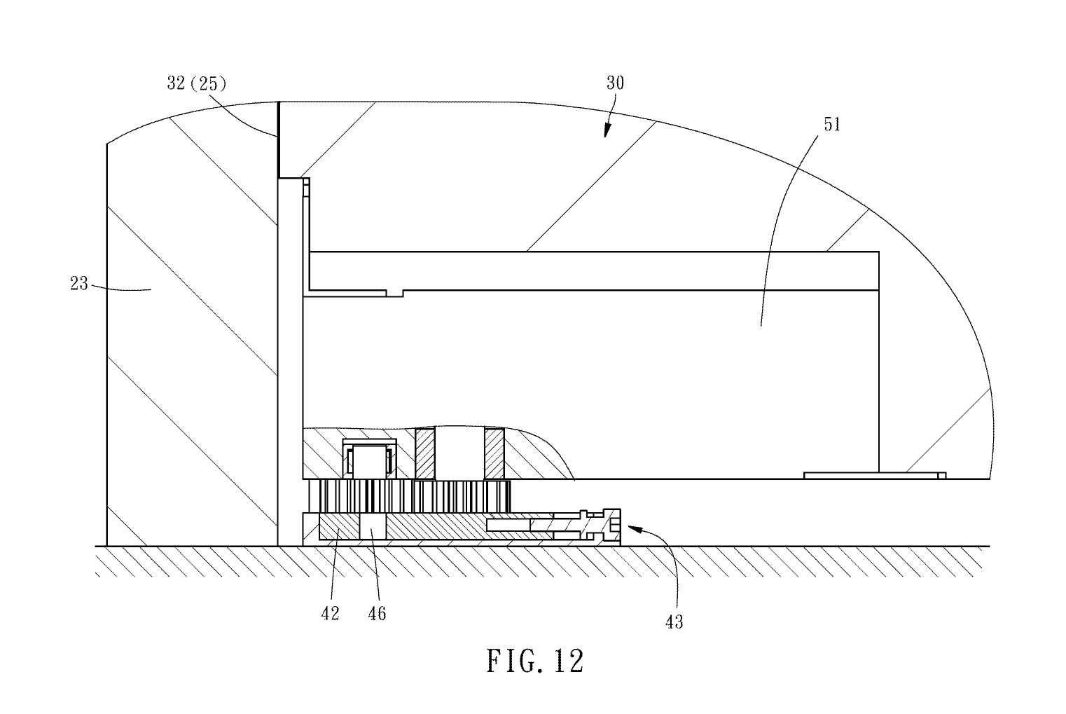

The adjustment screw 43 comprises a screw head 431 and a screw shank 432. As illustrated in FIG. 10, the screw head 431 is positioned in the end groove 414 of the holder frame 41 and abutted against the stop portions 412 of the holder frame 41 at an outer side (the side of the stop portions 412 opposite to the accommodation chamber 411). The screw shank 432 is inserted through the gap 413 of the holder frame 41, having one end thereof fixedly connected to the screw head 431 and an opposite end thereof threaded into the adjustment screw hole 421 of the movable plate 42. Thus, as illustrated in FIGS. 1 and 12, the adjustment screw 43 can be driven to rotate on the axis thereof by a hand tool (not shown). When the adjustment screw 43 is rotated, the movable plate 42 is caused to move toward the first door jamb 23 of the door panel 30.

The stop ring 44 is affixed to the screw shank 432 of the adjustment screw 43 and abutted against an opposing inner side of the stop portions 412 of the holder frame 41 (the side of the stop portions 412 that faces toward the accommodation chamber 411), as illustrated in FIG. 10, to prohibit the adjustment screw 43 from falling out of the holder frame 41.

The abutment members 45 are respectively inserted into the through holes 415 of the holder frame 41. Each abutment member 45 has the distal end thereof extending out of the respective through hole 415 and stopped against one respective long side of the movable plate 42, as illustrated in FIG. 10, for adjusting the biasing angle of the movable plate 42. In order to facilitate adjustment, each abutment member 45 is configured to provide an outer thread around the periphery, and each through hole 415 is configured to provide an inner thread for the threading of the outer thread of the respective adjustment member 45. Thus, the user can use a hand tool (such as screwdriver) to drive each abutment member 45 axially forward or backward in the respective through hole 415.

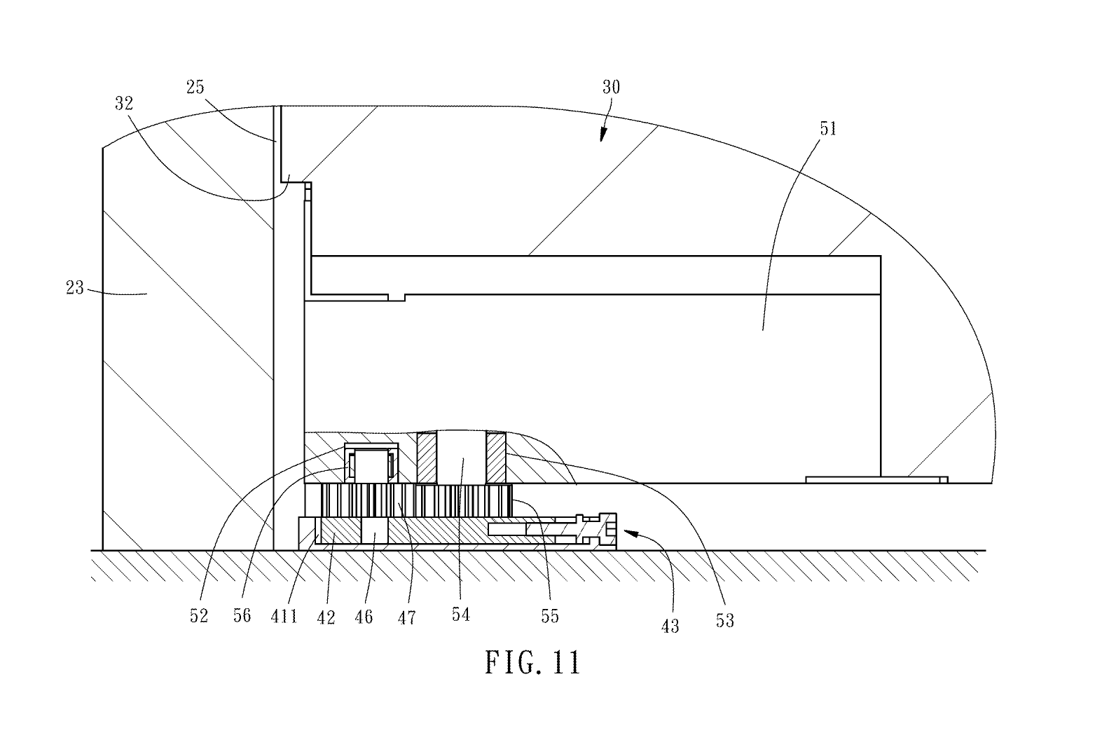

The locating shaft 46 has a bottom end thereof inserted into and affixed to the non-circular locating hole 422 of the movable plate 42, as illustrated in FIG. 9 and FIG. 11 so that the locating shaft 46 is movable with the movable plate 42.

The fixed gear 47 is fixedly mounted on the locating shaft 46 and abutted to a top surface of the movable plate 42, as illustrated in FIG. 9 and FIG. 11 so that on the one hand, the fixed gear 47 is prohibited from rotation on its own axis, and on the other hand, the fixed gear 47 can be moved with the locating shaft 46 and the movable plate 42.

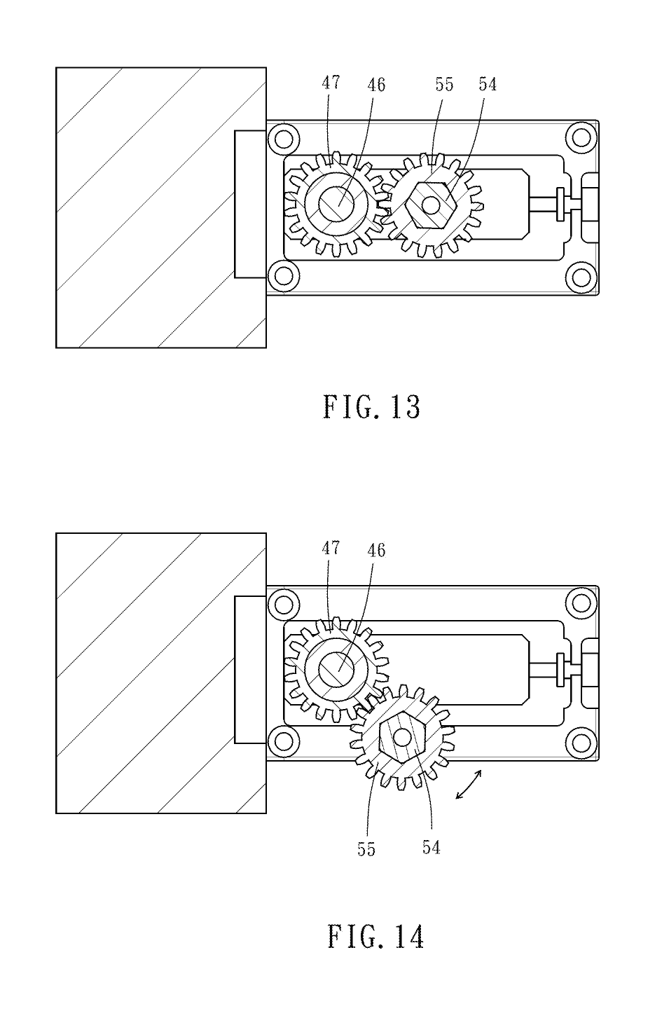

The door closer 50 comprises a body 51, a rotating shaft 54, and a transmission gear 55. Other component parts of the door closer 50 are of the known art and not within the scope of the invention, and we will not go into details herein. As illustrated in FIG. 4 and FIG. 11, the body 51 is mounted in the mounting hole 31 of the door panel 30, comprising a pivot hole 52 located on a bottom side near one end thereof and an axle hole 53 disposed adjacent to the pivot hole 62. The pivot hole 52 of the body 51 is pivotally coupled to an opposing end of the locating shaft 46 of the adjustment mechanism 40 by an axle bearing 56 so that the body 51 is biasable relative to the locating shaft 46 upon opening or closing of the door panel 30. As illustrated in FIG. 9 and FIG. 11, the top end of the rotating shaft 54 is disposed inside the body 51; the bottom end of the rotating shaft 54 extends downwardly out of the body 51. The transmission gear 55 is fixedly mounted on the bottom end of the rotating shaft 54 and meshed with the fixed gear 47 of the adjustment mechanism 40. Thus, when opening or closing the door panel 30, the transmission gear 55 is driven by the rotating shaft 54 to turn around the fixed gear 47, as illustrated in FIG. 13 and FIG. 14. Since the fixed gear 47 is not rotatable, the transmission gear 55 will rotate on its own axis when turned around the fixed gear 47. Thus, the rotating shaft 54 can be rotated with the transmission gear 55 to drive a damping unit (not shown) in the body 51, causing the damping unit to squeeze a hydraulic oil in producing a resistance against the opening or closing action of the door panel.

From the above we can see that the anti-folder hand safety door 10 utilizes the matching between the recess 25 of the door frame 20 and the convex hanging stile 32 of the door panel 30 to shield the door gap between the door panel 30 and the door frame 20 when the door panel 30 is opened through an angle (see FIG. 7 and FIG. 8). After installation of the door panel 30 or after several uses of the door panel 30, the adjustment screw 43 can be rotated to adjust the position of the movable plate 42 relative to the first door jamb 23 of the door frame 20. When rotating the adjustment screw 43 to move the movable plate 42 toward the first door jamb 23 of the door frame 20, as illustrated in FIG. 11 and FIG. 13, the locating shaft 46 is moved with the movable plate 42 to drive the body 51 and the door panel 30 toward the first door jamb 23 of the door frame 20, ensuring that the convex hanging stile 32 of the door panel 30 can be received in the recess 25 of the door frame 20 when the door panel 30 is closed. Further, the abutment members 45 can be moved to finely adjust the bias angle of the movable plate 42, ensuring that the door panel 30 maintains its proper position when closed (for example, the position shown in FIG. 6 where the convex hanging stile 32 of the door panel 30 is disposed in the middle of the recess 25 of the door frame 20. Thus, the anti-folder hand safety door 10 prevents jammed finger injuries to ensure safe use without affecting closing and opening of the door panel, and allows adjustment of the position of the door panel 30 at anytime in a convenient manner, achieving the purpose of enhancing the safety and convenience of use.

What is claimed is:

1. An anti-folder hand safety door, comprising:
a door frame comprising a header, a threshold, a first door jamb and a second door jamb, said first door jamb and said second door jamb being bilaterally connected between said header and said threshold to face toward each other, said first door jamb comprising a recess located on one side thereof and facing toward said second door jamb;
a door panel comprising a top side pivotally connected to said header of said door frame, an opposing bottom side, a mounting hole defined in the bottom side thereof and a convex hanging stile located on one lateral side thereof and facing toward said first door jamb of said door frame, said convex hanging stile being received in said recess of said first door jamb of said door frame when said door panel is closed in said door frame;
an adjustment mechanism comprising a holder frame, a movable plate, a locating shaft and a fixed gear, said holder frame being mounted to a top surface of said threshold of said door frame adjacent to said first door jamb of said door frame, said movable plate being mounted in said holder frame and movable toward said first door jamb of said door frame, said locating shaft having a bottom side thereof affixed to said movable plate, said fixed gear being fixedly mounted on said locating shaft; and
a door closer comprising a body, a rotating shaft and a transmission gear, said body being mounted in said mounting hole of said door panel and pivotally connected to an opposing top side of said locating shaft so that said body is turnable about said locating shaft when said door panel is opened from said door frame, said rotating shaft being rotatably mounted in said body with a top end thereof disposed inside said body and an opposing bottom end thereof extended outside said body, said transmission gear being affixed to the bottom end of said rotating shaft and meshed with said fixed gear of said adjustment mechanism for driving said rotating shaft to rotate relative to said body.

2. The anti-folder hand safety door as claimed in claim 1, wherein said movable plate comprises an adjustment screw hole located on one end thereof; said adjustment mechanism further comprises an adjustment screw mounted in said adjustment screw hole of said movable plate and rotatable to move said movable plate toward said first door jamb of said door panel.

3. The anti-folder hand safety door as claimed in claim 2, wherein said holder frame comprises an accommodation chamber adapted for accommodating said movable plate, two stop portions located at one end thereof, and a gap defined between said two stop portions; said adjustment screw comprises a screw head abutted against said two stop portions at one side opposite to said accommodation chamber, and a screw shank fixedly connected to said screw head and extending through said gap into said accommodation chamber and threaded into said adjustment screw hole of said movable plate.

4. The anti-folder hand safety door as claimed in claim 3, wherein said adjustment mechanism further comprises a stop ring affixed to said screw shank of said adjustment screw and stopped against said stop portions at an inner side to face toward said accommodation chamber.

5. The anti-folder hand safety door as claimed in claim 3, wherein said holder frame further comprises an end groove located on the said one end in communication with said gap; said screw head of said adjustment screw is set in said end groove.

6. The anti-folder hand safety door as claimed in claim 3, wherein said holder frame further comprises two through holes symmetrically located on two opposite lateral sides thereof in communication with said accommodation chamber and extending perpendicular to the axis of said adjustment screw hole; said adjustment mechanism further comprises two abutment members respectively movably mounted in said through holes of said holder frame and stopped against said movable plate.

7. The anti-folder hand safety door as claimed in claim 1, wherein said recess of said door panel is a rectangular groove.

8. The anti-folder hand safety door as claimed in claim 7, wherein said recess of said door frame extends from a bottom side of said header of said door frame to a top side of said threshold of said door frame.

9. The anti-folder hand safety door as claimed in claim 8, wherein the extending length of said convex hanging stile of said door panel is equal to the extending length of said recess of said door frame.

10. The anti-folder hand safety door as claimed in claim 7, wherein the width of said recess of said door frame is larger than the thickness of said door panel.
